(19) United States
(12) Patent Application Publication
(10) Pub. No.: US 2012/0020713 A1
(43) Pub. Date: Jan. 26, 2012

(54) IMAGE FORMING APPARATUS

(75) Inventors: Akira ISHII, Kanagawa (JP); Masao ITO, Kanagawa (JP)

(73) Assignee: FUJI XEROX CO., LTD., Tokyo (JP)

(21) Appl. No.: 13/017,546

(22) Filed: Jan. 31, 2011

(30) Foreign Application Priority Data
Jul. 21, 2010 (JP) 2010-163987

(51) Int. Cl. G03G 15/00

(52) U.S. Cl. 399/388

(57) ABSTRACT

An image forming apparatus includes a transporting mechanism that transports a sheet along a transport path; an image forming mechanism that forms an image on the sheet; a reading mechanism that is provided at one side of the transport path, and that reads the image; a rotary member that is provided at the other side of the transport path, and that is disposed opposite to the reading mechanism, a gap being formed between the rotary member and the reading mechanism, and having a shape allowing a size of the gap to change as the rotary member rotates; and a changing mechanism that, when the sheet passes through the gap without performing the image reading, changes the size of the gap on the basis of the rotary member shape.

### CROSS-REFERENCE TO RELATED APPLICATIONS

This application is based on and claims priority under 35 USC 119 from Japanese Patent Application No. 2010-163987 filed Jul. 21, 2010.

### BACKGROUND

(i) Technical Field

The present invention relates to an image forming apparatus.

### SUMMARY

According to an aspect of the invention, there is provided an image forming apparatus including a transporting mechanism that transports a sheet along a transport path; an image forming mechanism that forms an image on the sheet transported by the transporting mechanism; a reading mechanism that is provided at one side of the transport path, and that reads the image formed by the image forming mechanism on the sheet transported by the transporting mechanism; a rotary member that is provided at the other side of the transport path, and that is disposed opposite to the reading mechanism, a gap being formed between the rotary member and the reading mechanism, the rotary member being rotatable and having a shape that allows a size of the gap to change as the rotary member rotates; and a changing mechanism that, when the sheet passes through the gap without performing the image reading by the reading mechanism, changes the size of the gap on the basis of the shape of the rotary member by rotating the rotary member, the changed size of the gap being larger than the size of the gap during the image reading by the reading mechanism.

### BRIEF DESCRIPTION OF THE DRAWINGS

Exemplary embodiments of the present invention will be described in detail based on the following figures, wherein:

FIG. 1 is a schematic view of the structure of an image forming apparatus according to an exemplary embodiment of the present invention;

FIG. 2 is an enlarged view of a portion C in FIG. 1;

FIG. 3 illustrates a passing portion;

FIG. 4 is a perspective view of a rotary member;

FIG. 5 shows a contour of the rotary member;

FIG. 6 shows the passing portion after the rotary Member is rotated; and

FIG. 7 illustrates a color proof plate.

### DETAILED DESCRIPTION

An exemplary embodiment for carrying out the present invention will hereunder be described with reference to the attached drawings.

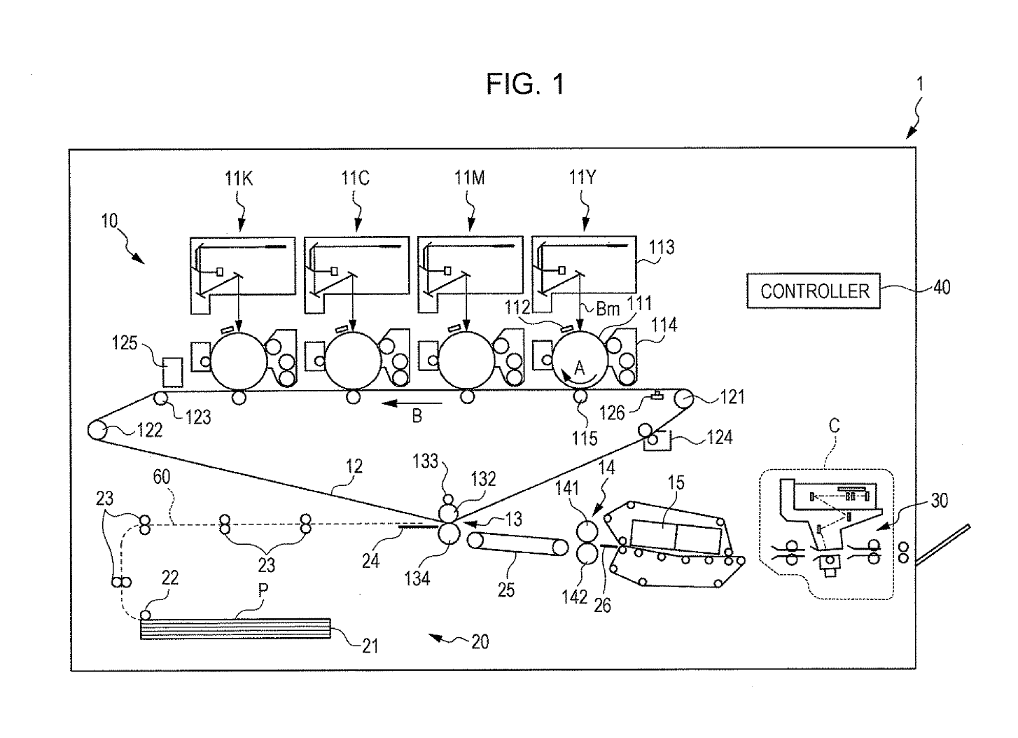

FIG. 1 is a schematic view of the structure of an image forming apparatus 1 according to an exemplary embodiment of the present invention.

The image forming apparatus 1 shown in FIG. 1 is an image forming apparatus using a tandem system, and includes an image forming section 10, a sheet transport section 20, an image reading section 30, and a controller 40.

The image forming section 10 (which is an exemplary image forming mechanism) includes image forming units 11 (11Y, 11M, 11C, 11K), an intermediate transfer belt 12, a second transfer unit 13, a fixing unit 14, and a cooling unit 15. The image forming units 11 correspond to the four image forming units 11Y, 11M, 11C, and 11K corresponding to toners of four colors, yellow (Y), magenta (M), cyan (C), and black (K). Here, the four image forming units 11Y, 11M, 11C, and 11K are disposed in parallel in a movement direction of the intermediate transfer belt 12, and form toner images by an electrophotographic system. Each image forming unit 11 includes, for example, a photoconductor drum 111, a charger 112, an exposure unit 113, a developing unit 114, and a first transfer unit 115. The image forming units 11 form the toner images of the respective colors Y, M, C, and K, transfer the toner images onto the intermediate transfer belt 12, and form on the intermediate transfer belt 12 a toner image in which the toner images of the respective colors Y, M, C, and K are superposed upon each other.

Here, the photoconductor drums 111 rotate in the direction of arrow A in FIG. 1 at a predetermined speed, and have electrostatic latent images formed on peripheral surfaces thereof. The chargers 112 charge the peripheral surfaces of the photoconductor drums 111 to predetermined electric potentials. The exposure units 113 radiate the peripheral surfaces of the charged photoconductor drums 111 with beams (refer to reference character Bm in FIG. 1), to form the electrostatic latent images on the peripheral surfaces of the photoconductor drums 111. The developing units 114 cause toner to adhere to the electrostatic latent images formed on the peripheral surfaces of the photoconductor drums 111, to form toner images. The first transfer units 115 transfer (that is, performs a first transfer operation on) the toner images formed on the peripheral surfaces of the respective photoconductor drums 111 onto the intermediate transfer belt 12. Here, a voltage having a polarity that is opposite to a charging polarity of the toner is applied to each first transfer unit 115. The toner images formed on the peripheral surfaces of the photoconductor drums 111 are successively electrically attracted to the intermediate transfer belt 12, so that a color toner image formed by superimposing the toner images upon each other is formed.

The intermediate transfer belt 12 is supported by rollers. The intermediate transfer belt 12 is a belt-like member that circulates in the direction of arrow B. Here, in the exemplary embodiment, the rollers include a driving roller 121 that is driven by a motor (not shown) and that drives the intermediate transfer belt 12, a tension roller 122 that applies tension to the intermediate transfer belt 12 and that prevents a meandering phenomenon in the intermediate transfer belt 12, an idle roller 123 that supports the intermediate transfer belt 12, and a back-up roller 132.

The sheet transport section 20 includes a sheet holding section 21 that holds sheets P in a stacked state, a pickup roller 22 that takes out and transports the sheets P held in the sheet holding section 21 at a predetermined timing, transport rollers 23 that function as portions of a transporting mechanism that transports the sheets P taken out by the pickup roller 22 along a sheet transport path 60, a transport chute 24 that sends the sheets P transported by the transport rollers 23 to the second transfer unit 13, a transport belt 25 that transports the sheets P after a second transfer operation to the fixing unit 14, and a transport chute 26 that sends the sheets P after a fixing operation to the cooling unit 15.

The second transfer unit 13 includes a second transfer roller 134 disposed so as to contact the outer side of the intermediate transfer belt 12, and a back-up roller 132 disposed at the inner side of the intermediate transfer belt 12 and serving as an opposing electrode of the second transfer roller 134. In the exemplary embodiment, a power-supply roller 133 that applies a second transfer bias to the back-up roller 132 is provided. A brush roller (not shown) that removes any dirt adhered to the second transfer roller 134 is also provided. The second transfer unit 13 that is formed in this way transfers (that is, performs the second transfer operation on) the toner images, formed on the intermediate transfer belt 12, onto the transported sheets P.

In the exemplary embodiment, a belt cleaner 124 that cleans the outer peripheral surface of the intermediate transfer belt 12 after the second transfer operation is provided downstream from the second transfer unit 13 in a direction of movement of the intermediate transfer belt 12. An image density sensor 125 used in adjusting image quality is disposed upstream from the second transfer unit 13 in the direction of movement of the intermediate transfer belt 12. A reference sensor (home position sensor) 126 that generates a reference signal serving as a reference for a timing in which an image is formed in each image forming unit 11 is disposed upstream from the yellow image forming unit 11Y in the direction of movement of the intermediate transfer belt 12. The reference sensor 126 generates the reference signal by recognizing a mark provided at the inner peripheral surface of the intermediate transfer belt 12. In the exemplary embodiment, each image forming unit 11 is formed so as to start forming the images on the basis of the reference signal.

The fixing unit 14 is disposed downstream from the second transfer unit 13 in a direction of transport of the sheets P. The fixing unit 14 includes a fixing roller 141 having a heating source (not shown), and a pressure roller 142 that is provided so as to oppose the fixing roller 141 and that presses the fixing roller. Here, when a sheet P that has passed the second transfer unit 13 is transported to a location between the fixing roller 141 and the pressure roller 142, unfixed toner images on the sheet P are fused by the fixing roller 141 to fix them to the sheet P. This forms an image formed by the toner images on the sheet P. In the exemplary embodiment, the cooling unit 15 is provided downstream from the fixing unit 14 in the direction of transport of the sheets P. The cooling unit 15 cools the sheet P transported from the fixing unit 14. This causes the toner on the sheet P to be solidified.

Next, the image reading section 30 will be described.

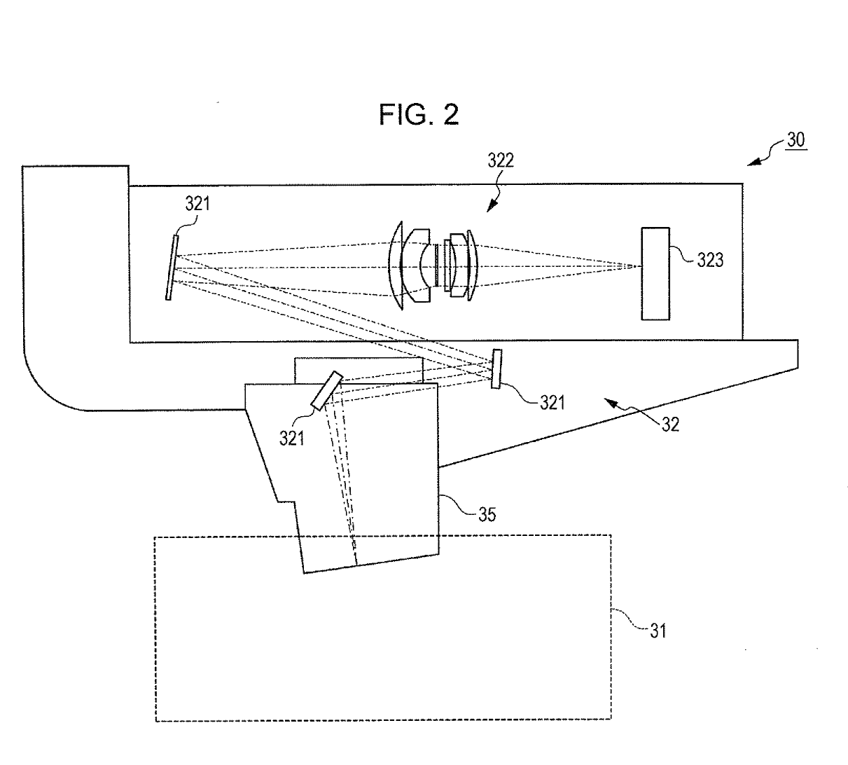

FIG. 2 is an enlarged view of a portion C in FIG. 1.

As shown in FIG. 1, the image reading section 30 is provided downstream from the cooling unit 15 in the direction of transport of the sheets. The image reading section 30 optically reads a test chart (not shown), which the image forming section 10 forms on a sheet P, for example, when a power supply is turned on, so that image data is generated. Here, in the exemplary embodiment, the generated image data is transmitted to the controller 40 (see FIG. 1). The controller 40 performs a processing operation for analyzing the received image data and stabilizing (improving) the image quality. More specifically, for example, the controller 40 analyzes the received image data and, first, determines whether or not the test chart is formed on the basis of a predetermined density, whether or not gradation is in a predetermined state, whether or not the position of formation of the test chart is not displaced, whether or not the form of the test chart is a predetermined form, etc. On the basis of the results of determination, if necessary, the controller 40 changes a parameter for the image formation. This stabilizes the quality of the image formed on the sheet P.

The controller 40 includes a central processing unit (CPU), read only memory (ROM), random access memory (RAM), and a hard disk drive (HDD), none of which are illustrated. At the CPU, a processing program is executed. Various programs, various tables, parameters, etc., are stored in ROM. RAM is used as, for example, a work area when the processing program is executed by the CPU.

As shown in FIG. 2, the image reading section 30 includes a passing portion 31 where a sheet P passes, a reading unit 32 that reads the test chart formed on the sheet P, and a supporting member 35 that supports the reading unit 32. The reading unit 32 includes three reflecting mirrors 321, an imaging lens 322, and an image sensor 323. The three reflecting mirrors 321 guide light that radiates the sheet P emitted from light sources 312 (described later) and that is reflected from the sheet P to the imaging lens 322. The imaging lens 322 causes the light guided by the three reflecting mirrors 321 and reflected from the sheet P to be focused on the image sensor 323. The image sensor 323 includes an image pickup element. The image sensor 323 receives the light focused by the imaging sensor 322, and generates image data in accordance with the amount of received light. In the exemplary embodiment, the reading unit 32, the supporting member 35, a transmission plate 313 (described later), etc., are capable of being set as a reading mechanism that is provided at one side of the sheet transport path 60 (see FIG. 1) and that reads an image on the sheet P that is transported.

Next, the passing portion 31 will be described.

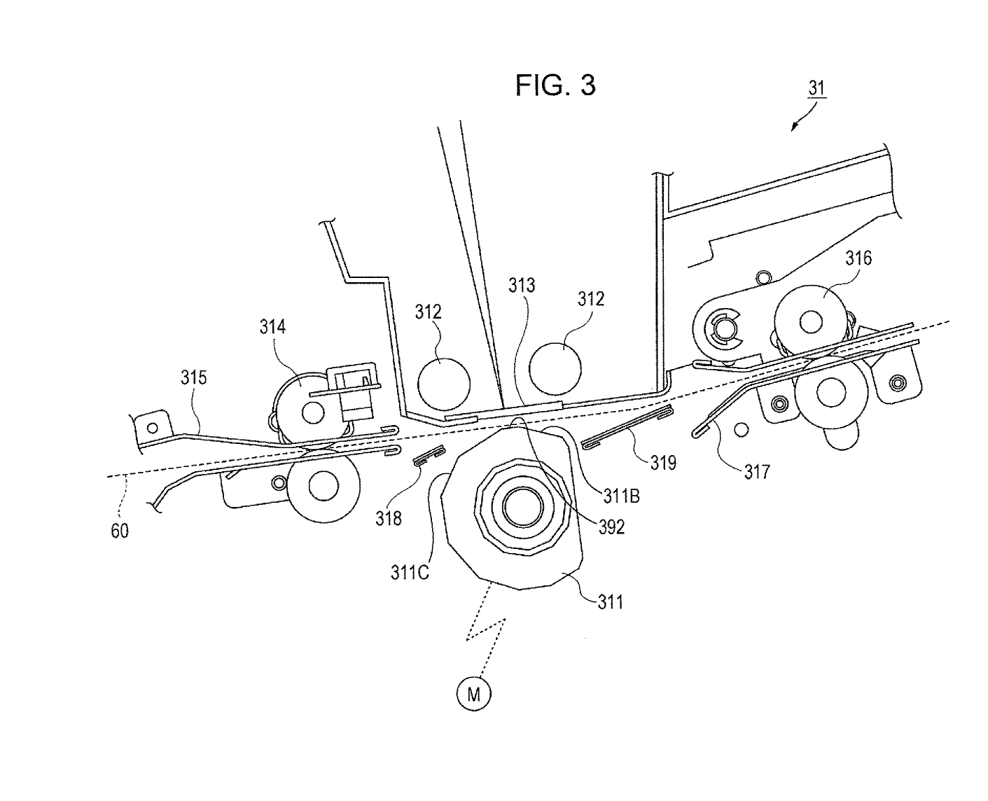

FIG. 3 illustrates the passing portion 31.

As shown in FIG. 3, in the passing portion 31, a rotary member 311 is provided below the sheet transport path 60 shown by broken lines. The rotary member 311 is rotated by a motor M functioning as part of a driving mechanism and a changing mechanism. In the exemplary embodiment, the light sources 312 that radiate the sheet P that is transported along the sheet transport path 60 are provided at locations above the sheet transport path 60 and opposite to the rotary member 311. The transmission plate 313 is transparent and is provided between the sheet transport path 60 and the light sources 312. The transmission plate 313 transmits light emitted from the light sources 312 and light reflected from the sheet P. Here, in the exemplary embodiment, a gap is formed between the transmission plate 313 and the rotary member 311. The sheet P passes through this gap. When the sheet P passes through this gap, the test chart formed on the sheet P is read. The light reflected from the sheet P passes through the transmission plate 313, and, then, reaches the reflecting mirrors 321.

A pair of first transport rollers 314, a first guide 315, a pair of second transport rollers 316, and a second guide 317 are provided at the passing portion 31. The pair of first transport rollers 314 transport the sheet P transported from an upstream side to the aforementioned gap. The first guide 315 includes two plate-like members disposed so as to oppose each other, and guides the sheet P transported from the upstream side to the gap. The pair of second transport rollers 316 further transport downstream the sheet that has passed through the gap. The second guide 317 includes two plate-like members disposed so as to oppose each other, and guides the sheet P so that the sheet P that has passed through the gap is transported downstream.

A third guide 318 is disposed below the sheet transport path 60 and between the first guide 315 and the rotary member 311, and guides the sheet P that is transported. A fourth guide 319 is disposed below the sheet transport path 60 and between the rotary member 311 and the second guide 317, and guides the sheet P that is transported. The third guide 318 and the fourth guide 319 are each formed in the form of a plate, and are each disposed in an inclined state with its distance from the sheet transport path 60 decreasing as it extends downstream in the transport direction of the sheet P.

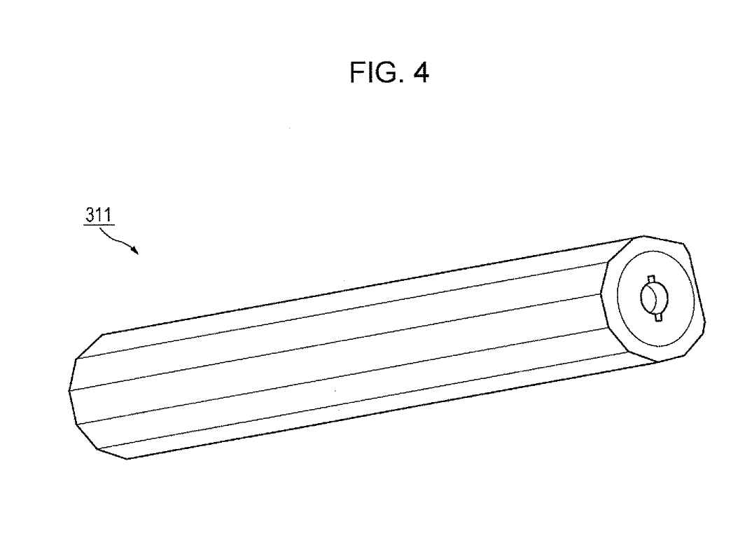

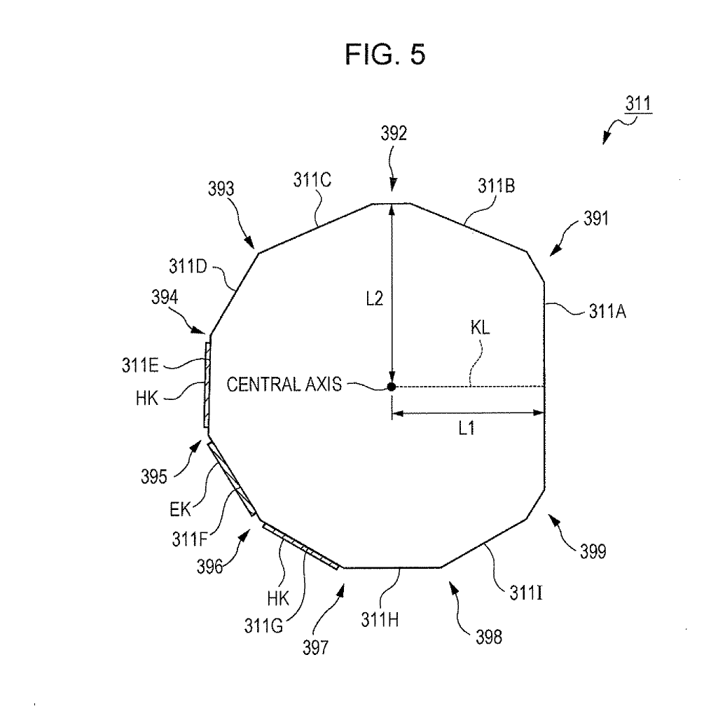

Here, the rotary member 311 will be described with reference to FIG. 4 (which is a perspective view of the rotary member 311) and FIG. 5 (which shows a contour of the rotary member 311).

As shown in FIG. 4, the rotary member 311 has a columnar shape. As shown in FIG. 5, the rotary member 311 has a form in which a portion thereof is cut away, so that the rotary member 311 has a flatly machined portion in a portion of its outer peripheral surface. In other words, the flatly machined portion has a flat surface 311A formed along an axial direction of the rotary member 311. Here, the flat surface 311A, serving as an exemplary first portion, is disposed so as to be orthogonal to an imaginary line KL extending in a radial direction from a center axis (rotational center) of the rotary member 311. The flat surface 311A is provided so as to be separated by a distance L1 (first distance) from the center axis of the rotary member 311.

The rotary member 311 has top portions provided at different locations in a peripheral direction. Here, the top portions are provided along the axial direction of the rotary member 311. In the exemplary embodiment, nine top portions are provided, that is, a first top portion 391, a second top portion 392, a third top portion 393, a fourth top portion 394, a fifth top portion 395, a sixth top portion 396, a seventh top portion 397, an eighth top portion 398, and a ninth top portion 399.

Further, in the exemplary embodiment, nine flat surfaces are provided along the axial direction of the rotary member 311, and connect the top portions that are adjacent thereto. The nine flat surfaces include the flat surface 311A and flat surfaces 311B to 311I. Here, in the exemplary embodiment, the distance between the second top portion 392 (an exemplary second portion) and the central axis of the rotary member 311 is a distance L2 (second distance) that is greater than the distance L1. Although not described above, in the state shown in FIG. 3, the rotary member 311 is disposed in a state in which the second top portion 392 opposes the transmission plate 313.

Here, in the exemplary embodiment, as described above, the reading unit 32 is made to read the test chart on the sheet P. Here, if the gap formed between the transmission plate 313 and the rotary member 311 is large, the behavior of the sheet P that is transported becomes unstable, thereby also reducing the quality of an image that is read. Therefore, in the exemplary embodiment, as described above, the rotary member 311 is disposed in the state in which the second top portion 392 (an exemplary predetermined portion) opposes the transmission plate 313, so that the gap between the transmission plate 313 and the rotary member 311 is small.

In the image forming apparatus 1 in the exemplary embodiment, obviously, not only the sheet P having the test chart formed thereon, but also sheets P having ordinary images formed thereon are also transported. That is, sheets P whose images do not need to be read by the reading unit 32 are also transported. In other words, sheets P whose images are not read by the reading unit 32 also pass between the transmission plate 313 and the rotary member 311. Here, when such sheets P are transported, if the gap between the transmission plate 313 and the rotary member 311 is small, jamming of the sheets tend to occur. Therefore, in the exemplary embodiment, when the sheets P having ordinary images formed thereon are transported, the rotary member 311 is rotated counterclockwise, to increase the size of the gap between the transmission plate 313 and the rotary member 311. That is, the shape of the path along which the sheets P pass is switched. More specifically, the rotary member 311 in the exemplary embodiment is formed so as to have a shape whose distance from the transmission plate 313 changes as it rotates (that is, a shape formed so that the size of the gap changes). In the exemplary embodiment, the distance between the rotary member 311 and the transmission plate 313 is increased by rotating the rotary member 311.

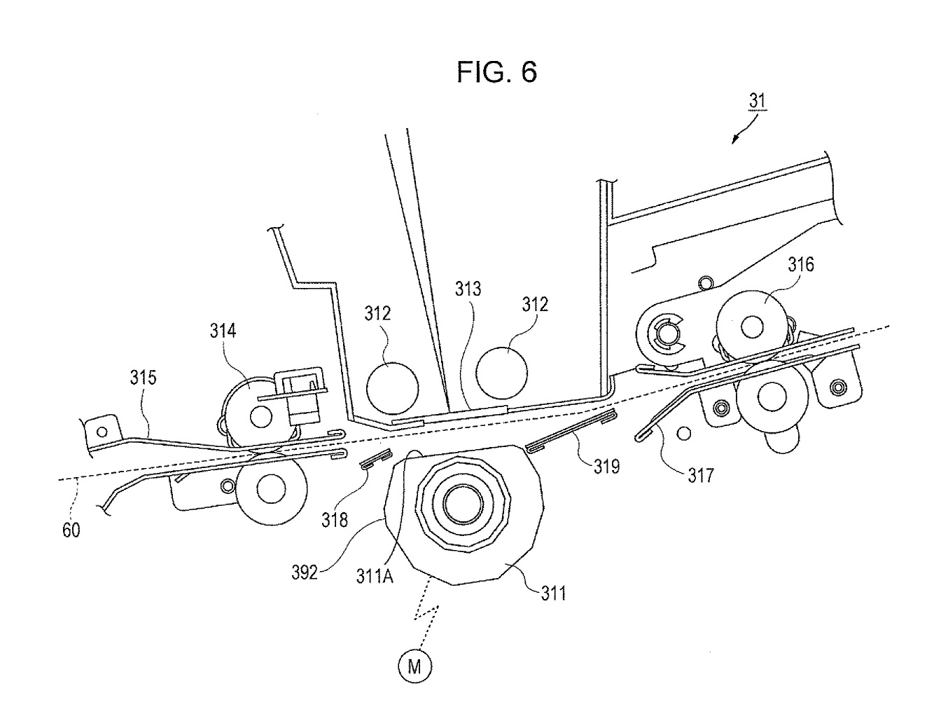

FIG. 6 shows the passing portion 31 after the rotary member 311 is rotated.

As described above, in the exemplary embodiment, when the sheets P having ordinary images formed thereon are transported, the rotary member 311 is rotated counterclockwise, to increase the size of the gap between the transmission plate 313 and the rotary member 311. More specifically, the rotary member 311 is rotated counterclockwise so that the flat surface 311A opposes the transmission plate 313. Accordingly, as shown in FIG. 6, the size of the gap between the transmission plate 313 and the rotary member 311 is increased, so that jamming occurs infrequently. As shown in FIG. 3, when the size of the gap between the transmission plate 313 and the rotary member 311 is small, the transmission plate 313 tends to become dirty due to toner images formed on the sheets P. In addition, in this case, the quality of the image data for when the test chart is read is reduced. Here, as shown in FIG. 6, when the size of the gap between the transmission plate 313 and the rotary member 311 is increased, the sheets P contact the transmission plate 313 less frequently, so that the transmission plate 313 becomes dirty less frequently.

The test chart is capable of being read using a 1× magnification optical system, which performs reading using, for example, a selfoc lens (trade mark), instead of a reduction optical system as in the exemplary embodiment. The size of the gap through which the sheets P pass is capable of being increased by moving (retracting) the 1× magnification optical system. However, in this case, the mechanism becomes a large-scale mechanism, as a result of which the apparatus becomes large. In contrast, in the exemplary embodiment, since the size of the gap is increased by rotating the rotary member 311, it is possible suppress an increase in the size of the apparatus.

Although not described above, in the state in which the transmission plate 313 and the second top portion 392 oppose each other (see FIG. 3), the flat surface 311C is disposed upstream from the second top portion 392 in the transport direction of the sheet P so that its distance from the sheet transport path 60 (that is, the transmission plate 313) decreases as the flat surface 311C extends downstream in the transport direction of the sheet P. Here, when the flat surface 3110 is provided, the sheet P is movable more smoothly. In addition, in the state in which the transmission plate 313 and the second top portion 392 oppose each other (see FIG. 3), the flat surface 311B is disposed downstream from the second top portion 392 so that its distance from the sheet transport path 60 (that is, the transmission plate 313) increases as the flat surface 311E extends downstream in the transport direction of the sheet P. Here, when such a flat surface 311B is provided, the resistance of the rotary member 311 acting upon the sheet P is reduced, so that the sheet P moves more smoothly.

In the exemplary embodiment, as shown in FIG. 6, a downstream-side end portion of the third guide 318 (that is, a downstream-side end portion in the transport direction of the sheet P) is positioned closer to the sheet transport path 60 than the flat surface 311A. Therefore, for example, a problem in which the movement of the sheet P is suppressed when the sheet P strikes the rotary member 311 occurs less frequently. Further, in the exemplary embodiment, as shown in FIG. 6, an upstream-side end portion of the fourth guide 319 (that is, an upstream-side end portion in the transport direction of the sheet P) is positioned further away from the sheet transport path 60 than the flat surface 311A. Therefore, the sheet P is more reliably guided by the fourth guide 319.

The rotary member 311 will be further described. Although not described above, as shown in FIG. 5, white reference plates HK (exemplary correcting members) are provided at the flat surface 311E and the flat surface 311G of the rotary member 311, respectively. Here, when the two reference plates HK of one type are provided so as to be separated from each other, for example, the two reference plates HK less frequently become dirty at the same time. A color proof plate EK (another exemplary correcting member) is provided at the flat surface 311F of the rotary member 311. Here, the reference plates HK and the color proof plate EK are formed to be long, and are provided along the longitudinal direction of the rotary member 311.

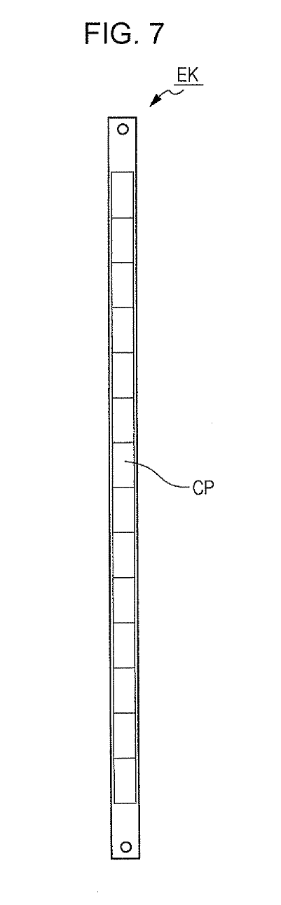

Here, as shown in FIG. 7 (illustrating the color proof plate EK), color patches CP of different colors are formed in the color proof plate EK so as to be disposed in parallel in the longitudinal direction of the color proof plate EK. Here, when the reference plates HK and the color proof plate EK are provided at the rotary member 311, it is possible to cause the reference plates HK and the color proof plate EK to oppose the transmission plate 313 using a common (one) driving source, so that the number of driving sources is capable of being reduced. Compared to the case in which the reference plates HK and the color proof plate EK are provided at locations other than at the rotary member 311, it is possible to reduce the size of the image forming apparatus 1.

Here, in the exemplary embodiment, for example, the reference plate HK provided at the flat surface 311E is caused to oppose the transmission plate 313 by rotating the rotary member 311. In a state in which a sheet P does not exist between the transmission plate 313 and the rotary member 311, a reading operation is carried out using the reading unit 32. This makes it possible to obtain shading data used in shading correction. Here, the term “shading correction” refers to a processing operation for correcting variations in optical distributions in the image sensor 323 (see FIG. 2), such as differences between sensitivities of photoelectric conversion elements of the image sensor 323, and variations in light quantity of the light sources 312 (see FIG. 3). In the exemplary embodiment, on the basis of the shading data, test chart reading results are corrected for respective pixels, so that the aforementioned variations are eliminated.

In the exemplary embodiment, after reading the reference plate HK provided at the flat surface 311E, the reference plate HK provided at the flat surface 311G is read. Pieces of light quantity data for the respective pixels are compared with each other, and the light quantity data having a larger value is used. Therefore, even if, for example, dirt adheres to a portion of one of the reference plates HK, the influence of the dirt is capable of being made small.

In addition, in the exemplary embodiment, the color proof plate EK provided at the flat surface 311F is caused to oppose the transmission plate 313 by rotating the rotary member 311. In the state in which a sheet P does not exist between the transmission plate 313 and the rotary member 311, a reading operation is carried out using the reading unit 32. In this exemplary embodiment, on the basis of reading results of the reading unit 32, a correction coefficient for correcting image data for when the test chart is read is calculated. Here, for example, the colors of the light sources 312 may change with the passage of time. When the colors of the light sources 312 change, the test chart is no longer precisely read. Therefore, in the exemplary embodiment, by correcting the image data using the correction coefficient that is calculated as mentioned above, it is possible for the image data (of the test chart) to be one that is little influenced by, for example, changes in the colors of the light sources 312.

Although not described above, in the state in which the transmission plate 313 and the second top portion 392 oppose each other (see FIG. 3), the second top portion 392 is positioned at a location that is separated from the passing plate 131 by the first distance. In addition, in the exemplary embodiment, in a state in which the transmission plate 313 and each reference plate HK oppose each other (see FIG. 5), the reference plates HK are also positioned at locations that are separated from the transmission plate 313 by the first distance. Further, in a state in which the transmission plate 313 and the color proof plate EK oppose each other (see FIG. 5), the color proof plate EK is also positioned at a location that is separated from the transmission plate 313 by the first distance.

That is, the second top portion 392, the reference plates HK, and the color proof plate EK are provided at locations that are situated at the distance L2 from the central axis of the rotary member 311 (see FIG. 5). Therefore, the distance between the transmission plate 313 and the second top portion 392 when they oppose each other and the distance between the transmission plate 313 and each reference plate HK when they oppose each other are equal to each other. In addition, the distance between the transmission plate 313 and the second top portion 392 when they oppose each other and the distance between the transmission plate 313 and the color proof plate EK when they oppose each other are equal to each other.

An area whose uniformity of illumination performed using the light sources 312 (illumination depth) has a certain range (refer to FIG. 3). In the exemplary embodiment, when the test chart is being read, a sheet P passes within this range. Here, in the states in which the reference plates HK and the color proof plate EK oppose the transmission plate 313, if the reference plates HK and the color proof plate EK are positioned outside this range, a proper correction may not be performed. Therefore, in the exemplary embodiment, as described above, the reference plates HK and the color proof plate EK are also provided at the locations that are separated from the central axis of the rotary member 311 by the distance L2.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a transporting mechanism that transports a sheet along a transport path;
an image forming mechanism that forms an image on the sheet transported by the transporting mechanism;
a reading mechanism that is provided at one side of the transport path, and that reads the image formed by the image forming mechanism on the sheet transported by the transporting mechanism;
a rotary member that is provided at the other side of the transport path, and that is disposed opposite to the reading mechanism, a gap being formed between the rotary member and the reading mechanism, the rotary member being rotatable and having a shape that allows a size of the gap to change as the rotary member rotates; and
a changing mechanism that, when the sheet passes through the gap without performing the image reading by the reading mechanism, changes the size of the gap on the basis of the shape of the rotary member by rotating the rotary member, the changed size of the gap being larger than the size of the gap during the image reading by the reading mechanism.

2. The image forming apparatus according to claim 1, wherein the rotary member has a flatly machined portion at an outer peripheral surface thereof, the flatly machined portion being formed along an axial direction of the rotary member, and
wherein, when the sheet passes through the gap without performing the image reading by the reading mechanism, the changing mechanism causes the flatly machined portion of the rotary member to oppose the reading mechanism.

3. The image forming apparatus according to claim 1, wherein, when the image is read by the reading mechanism, a predetermined portion of the rotary member is disposed so as to oppose the reading mechanism, and
wherein, in a state in which the predetermined portion of the rotary member opposes the reading mechanism, the rotary member has a surface disposed upstream from the predetermined portion in a sheet transport direction so that a distance of the surface from the reading mechanism decreases as the surface extends downstream in the sheet transport direction.

4. The image forming apparatus according to claim 1, further comprising a correcting member used in correction of the reading mechanism,
wherein the correcting member is mounted to the rotary member.

5. The image forming apparatus according to claim 4, comprising a plurality of the correcting members,
wherein the correcting member opposing the reading mechanism is capable of being changed to another one of the correcting members as the rotary member rotates.

6. An image forming apparatus comprising:
a transporting mechanism that transports a sheet along a transport path;
an image forming mechanism that forms an image on the sheet transported by the transporting mechanism;
a reading mechanism that is provided at one side of the transport path, and that reads the image formed by the image forming mechanism on the sheet transported by the transporting mechanism;
a rotary member provided at the other side of the transport path, a gap being formed between the rotary member and the reading mechanism, the rotary member being rotatable around a predetermined rotational center, the rotary member including a first portion and a second portion disposed at different locations in a peripheral direction, the first portion being disposed at a first distance from the rotational center, the second portion being disposed at a second distance from the rotational center, the second distance being larger than the first distance; and
a driving mechanism that causes the rotary member to rotate and the second portion to oppose the reading mechanism when the image is read by the reading mechanism, and that causes the rotary member to rotate and the first portion to oppose the reading mechanism when the sheet passes through the gap without performing the image reading by the reading mechanism.

7. The image forming apparatus according to claim 6, wherein, in a state in which the second portion of the rotary member opposes the reading mechanism, the rotary member has a surface disposed upstream from the second portion of the rotary member in a sheet transport direction so that a distance of the surface from the reading mechanism decreases as the surface extends downstream in the sheet transport direction.

8. The image forming apparatus according to claim 6, wherein, in a state in which the second portion of the rotary member opposes the reading mechanism, the rotary member has a surface disposed downstream from the second portion of the rotary member in a sheet transport direction so that a distance of the surface from the reading mechanism increases as the surface extends downstream in the sheet transport direction.

9. The image forming apparatus according to claim 6, further comprising a correcting member used in correction of the reading mechanism,
wherein the correcting member is mounted to an outer peripheral surface of the rotary member.

10. The image forming apparatus according to claim 9, wherein, in a state in which the second portion opposes the reading mechanism, the second portion is positioned so as to be separated from the reading mechanism by the first distance, and
wherein, in a state in which the correcting member opposes the reading mechanism, the correcting member is positioned so as to be separated from the reading mechanism by the first distance.
